(19) United States
(12) Patent Application Publication
(10) Pub. No.: US 2017/0243326 A1
(43) Pub. Date: Aug. 24, 2017

(54) PIXEL DECIMATION FOR AN IMAGING SYSTEM

(71) Applicant: Seek Thermal, Inc., Santa Barbara, CA (US)

(72) Inventors: Jeffery Lee, Goleta, CA (US); Jason Wolfe, Santa Barbara, CA (US)

(21) Appl. No.: 15/436,626

(22) Filed: Feb. 17, 2017

Related U.S. Application Data
(60) Provisional application No. 62/297,669, filed on Feb. 19, 2016.

(51) Int. Cl. G06T 3/40; G06T 7/00; H04N 5/33

(52) U.S. Cl. CPC G06T 3/4023; H04N 5/33; G06T 7/0002

(57) ABSTRACT

Imaging systems and methods are disclosed that use decimate image data to create smaller image frame size from the image size acquired from an imaging array. An imaging system includes an array of photodetectors configured to produce an array of intensity values corresponding to light intensity at the photodetectors. The imaging system can be configured to acquire a frame of intensity values, or an image frame, and reduce the size of the image frame for subsequent processing and display. The decimation process includes replacing a subframe or kernel of image date with few pixels than contained in the kernel, including replacing the pixels of the kernel with one decimated pixel. The decimated pixel values are derived from the pixels of the kernel and may also include replacement of bad pixels in the original image frame.

### CROSS-REFERENCE TO RELATED APPLICATIONS

This application claims the benefit of U.S. Provisional Application Ser. No. 62/297,669, filed Feb. 19, 2016, entitled “PIXEL DECIMATION FOR AN IMAGING SYSTEM,” which is hereby incorporated by reference in its entirety and for all purposes.

### BACKGROUND

Field

The present disclosure generally relates to pixel decimation for imaging systems, such as cameras including infrared cameras for thermal imaging systems, and in particular to systems and methods for decimating image data to reduce image size for subsequent processing and display.

Description of Related Art

The increasing availability of high-performance, low-cost uncooled infrared imaging devices, such as bolometer focal plane arrays (FPAs), is enabling the design and production of mass-produced, consumer-oriented infrared (IR) cameras capable of quality thermal imaging. Such thermal imaging sensors have long been expensive and difficult to produce, thus limiting the employment of high-performance, long-wave imaging to high-value instruments, such as aerospace, military, or large-scale commercial applications. Mass-produced IR cameras may have different design requirements than complex military or industrial systems. New approaches to dynamically setting image size and image processing load, may be desirable for low-cost, mass-produced systems.

### SUMMARY

Example embodiments described herein have innovative features, no single one of which is indispensable or solely responsible for their desirable attributes. Without limiting the scope of the claims, some of the advantageous features will now be summarized.

In some embodiments, an imaging system includes an array of photodetectors configured to produce an array of intensity values corresponding to light intensity at the photodetectors. The imaging system can be configured to acquire a frame of intensity values, or an image frame, and decimate the image data to create smaller image frame size from the image size acquired from an imaging array for subsequent processing and display. The decimation process includes replacing a subframe or kernel of image data with fewer pixels than contained in the kernel, including replacing the pixels of the kernel with one decimated pixel. The decimated pixel values are derived from the pixels of the kernel and may also include replacement of bad pixels in the original image frame.

In a first aspect, a method is provided for an imaging system including an imaging sensor with an array of photodetectors. The method includes acquiring image data from the array of photodetectors, the acquired image data including an array of pixel intensity values each associated with a pixel of an acquired image. The method further may include dividing at least a portion of the acquired image data into a plurality of kernels, each kernel comprising the pixel intensity values associated with two or more of the pixels of the acquired image, and creating a decimated image comprising a number of pixels relatively smaller than the number of pixels in the acquired image, wherein a pixel intensity value of each pixel of the decimated image is derived from at least one of: one or more of the pixel intensity values within a kernel corresponding to the pixel of the decimated image, and one or more pixel intensity values of the acquired image data associated with pixels adjacent to the corresponding kernel.

In some embodiments, subsequent image processing and display is performed on the decimated image. In some embodiments, each pixel of the decimated image replaces two or more pixels of the corresponding kernel. In some embodiments, each pixel of the decimated image replaces all of the pixels of the corresponding kernel.

In some embodiments, the pixel intensity value of each decimated pixel is derived from good pixels of the corresponding kernel. In some embodiments, decimated image pixels include one or more of an average, a median, a peak value, a middle value, or a low value of the good pixels of the corresponding kernel.

In some embodiments, if a kernel has no good pixels, the pixel intensity values of decimated image pixels corresponding to the kernel are derived from the pixel intensity values of good pixels adjacent to the kernel.

In some embodiments, the kernels are 2×2 pixels and the number of pixels in the decimated image is ¼ the number of pixels of the acquired image. In some embodiments, decimation is performed on the acquired image and subsequent image processing is performed on the replacement pixels.

In some embodiments, the imaging sensor may include an infrared focal plane array.

In a second aspect, a thermal imaging system is provided that includes an imaging array comprising an infrared focal plane array. The infrared focal plane array maybe configured to generate signals corresponding to levels of infrared light incident on the infrared focal plane array. A detector circuit includes readout electronics that receive the generated signals and output image data that may include an array of pixel intensity values. The system also includes a system controller configured to acquire image data from the array of photodetectors, the acquired image data including an array of pixel intensity values each associated with a pixel of an acquired image. The system may also be configured to divide at least a portion of the image data into a plurality of kernels, each kernel including the pixel intensity values associated with two or more of the pixels of the acquired image, and create a decimated image which may include a number of pixels relatively smaller than the number of pixels in the acquired image. A pixel intensity value of each pixel of the decimated image may be derived from at least one of: one or more of the pixel intensity values within a kernel corresponding to the pixel of the decimated image, and one or more pixel intensity values of the acquired image data associated with pixels adjacent to the corresponding kernel.

In some embodiments, the system controller is further configured to perform subsequent image processing and display on the decimated image. In some embodiments, each pixel of the decimated image replaces two or more pixels of the corresponding kernel. In some embodiments, each pixel of the decimated image replaces all of the pixels of the corresponding kernel. In some embodiments, the pixel intensity value of each decimated image pixel is derived from good pixels of the corresponding kernel. In some embodiments, decimated image pixels include one or more of an average, a median, a peak value, a middle value, or a low value of the good pixels of the corresponding kernel. In some embodiments, if a kernel has no good pixels, the pixel intensity values of the decimated image pixels corresponding to the kernel are derived from one or more of an average, a median, a peak value, a middle value, or a low value of the pixel intensity values of good pixels adjacent to the kernel.

In some embodiments, the kernels are 2×2 pixels and the number of pixels in the decimated image is ¼ the number of pixels of the acquired image. In some embodiments, decimation is performed on the acquired image and subsequent image processing is performed on the replacement pixels.

In some embodiments, the imaging sensor includes an infrared focal plane array.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1A illustrates a functional block diagram of an example imaging system.

FIG. 1B illustrates a functional block diagram of the example imaging system illustrated in FIG. 1A, wherein functionality of the imaging system is divided between a camera and a processing device such as a personal electronic device.

FIGS. 2A through 2P illustrate examples of pixel decimation with bad pixel replacement for a 2×2 kernel.

FIG. 3 illustrates an example of pixel decimation when all four pixels of a 2×2 kernel are bad.

FIG. 4 is a flow chart of an example method for performing pixel decimation.

### DETAILED DESCRIPTION

Generally described, aspects of the present disclosure relate to decimating images to provide options for reduced image size for streamlined image processing, optional higher display frame rate, and for allowing for lower quality focal plane arrays (FPAs) to be utilized for systems with lower pixel resolution requirements. The decimation is done as part of the signal processing chain of an imaging system and operates on a frame or part of a frame acquired from the sensor (typically the FPA). The decimation is achieved on a kernel basis. The pixels in a given kernel are replaced with a smaller number of pixels derived from the kernel pixels, thus resulting in an image frame of reduced size. The present disclosure includes systems and methods to decimate an image to produce a corresponding smaller size image from acquired image sensor data. To decimate the image, the systems and methods disclosed herein replace the pixels of kernels of an image with a smaller number of pixels derived from the kernels. The derivation process may include averaging or finding the median of all or some groups of pixels within each kernel and using the results as replacement pixels. In some cases, one replacement pixel is calculated per kernel. The derivation process may also include bad pixel replacement. Thus, in some embodiments, these systems and methods can create a decimated image of lower size yet potentially higher quality than could be derived from the original sized image. Advantageously, this can allow the system to use streamlined subsequent image processing on decimated images allowing for systems with less processing capability and/or higher image display rates. Moreover, decimation may be used to allow the use of lower quality arrays that would be rejected for use in higher resolution system to be used successfully for lower resolution systems.

Although examples and implementations described herein focus, for the purpose of illustration, on implementation in an infrared camera and for thermal images, the systems and methods disclosed herein can be implemented in digital and/or video cameras that acquire visible light using a variety of image sensors. Various aspects of the disclosure will now be described with regard to certain examples and embodiments, which are intended to illustrate but not limit the disclosure.

Some embodiments described herein provide for pixel decimation that allows for the use of less capable processing devices in an imaging system. One design sensor may be manufactured and, for systems with lower processing capability, the pixel decimation may be accomplished early in the signal processing chain, allowing for subsequent processing on smaller image sizes. Thus one design sensor may be manufactured and used successfully in a variety of capability imaging systems.

Some embodiments described herein provide for image decimation that allows for higher display rate. Decimated, smaller sized images may be processed more quickly than full sized images, allowing for higher display refresh rates.

Some embodiments described herein provide for the use of image sensors (typically FPAs) of one design to be selected at test for systems of differing requirements. If a sensor of a certain size (e.g., pixel count) is manufactured, decimation with bad pixel replacement allows for sensors, which may have too many bad pixels for use in a system requiring the full image size, to be utilized in systems with smaller image size requirements. Thus manufacturing yield may be increased and sensor cost decreased.

The disclosed systems and methods for decimating an image may be implemented as modules that may be a programmed computer method or a digital logic method and may be implemented using a combination of any of a variety of analog and/or digital discrete circuit components (e.g., transistors, resistors, capacitors, inductors, diodes, etc.), programmable logic, microprocessors, microcontrollers, application-specific integrated circuits, or other circuit elements. A memory configured to store computer programs or computer-executable instructions may be implemented along with discrete circuit components to carry out one or more of the methods described herein. In certain implementations, the disclosed methods may be implemented in conjunction with a focal plane array (FPA) on a camera core, wherein the processor and memory components executing the disclosed methods may be on a processing device interfaced to the camera core, including smart phones, tablets, personal computers, etc. In some implementations, the processing and memory elements of the imaging system may be in programmable logic or on-board processors that are part of the core or camera system. In some embodiments, image gain calibration may be accomplished on a processing element on the camera core, and further image processing and display may be accomplished by a system controller mated to the core.

As a particular example of some advantages provided by the disclosed systems and methods, an imaging system can include a focal plane array (FPA) configured to acquire images of a scene. The FPA can include a two-dimensional array of N detectors, the FPA configured to output a two-dimensional image of the scene. For imaging purposes, image frames, typically data from all or some of the detectors, N_{f}, are produced by the FPA, each successive frame containing data from the array captured in successive time windows. Thus, a frame of data delivered by the FPA comprises N_{f} digital words, each word representing a particular pixel, P, in the image. These digital words are usually of a length determined by the analog to digital conversion (A/D) process. For example, if the pixel data is converted with a 14 bit A/D, the pixel words may be 14 bits in length, and there may be 16384 counts per word. For an IR camera used as a thermal imaging system, these words may correspond to an intensity of radiation measured by each pixel in the array. In a particular example, for a bolometer IR FPA, the intensity per pixel usually corresponds to temperature of the corresponding part of the imaged scene, with lower values corresponding to colder regions and higher values to hotter regions. It may be desirable to display this data on a visual display.

Each pixel in an FPA may include a radiation detector that generates relatively small signals in response to detected radiation, such as in an infrared imaging array. These signals may be relatively small compared to signals or signal levels in the FPA arising from sources not caused by incident radiation, or non-image signals, wherein these non-image signals are related to the materials, structure, and/or components of the FPA. For example, pixels in an FPA can include interface circuitry including resistor networks, transistors, and capacitors on a read out integrated circuit (ROIC) that may be directly interfaced to the array of detectors. For instance, a microbolometer detector array, a microelectrical mechanical system (MEMS) device, may be manufactured using a MEMS process. The associated ROIC, however, may be fabricated using electronic circuit techniques. These two components manufactured together to form the FPA. The combination of the interface circuitry and the detector itself may have offset and temperature behaviors that are relatively large compared to the signals produced in response to incident radiation on the detectors. Thus, it is often desirable to compensate for these effects that are not related to the image signal before displaying or otherwise processing the image data.

Examples of image processing systems and methods are disclosed in U.S. patent application Ser. No. 14/829,500, now U.S. Pat. No. 9,584,750, filed Aug. 18, 2015, U.S. patent application Ser. No. 14/292,124, filed May 30, 2014, U.S. patent application Ser. No. 14/829,490, filed Aug. 18, 2015, U.S. patent application Ser. No. 14/817,989, filed Aug. 4, 2015, U.S. patent application Ser. No. 14/817,847, filed Aug. 4, 2015, each of which is incorporated by reference herein in its entirety. These referenced applications describe a variety of imaging system configurations and various techniques for adjusting for artifacts and correcting for degradations in image quality that arise at least in part due to various properties and characteristics of the imaging systems. These various image processing functions may be accomplished in a processing unit, which, as described, may either be part of a camera device, a processing device interfaced to the camera device, and/or distributed between the two. The processing power required and accordingly the speed at which images are processed depend on the image size (e.g., pixel count).

### Example Imaging Systems

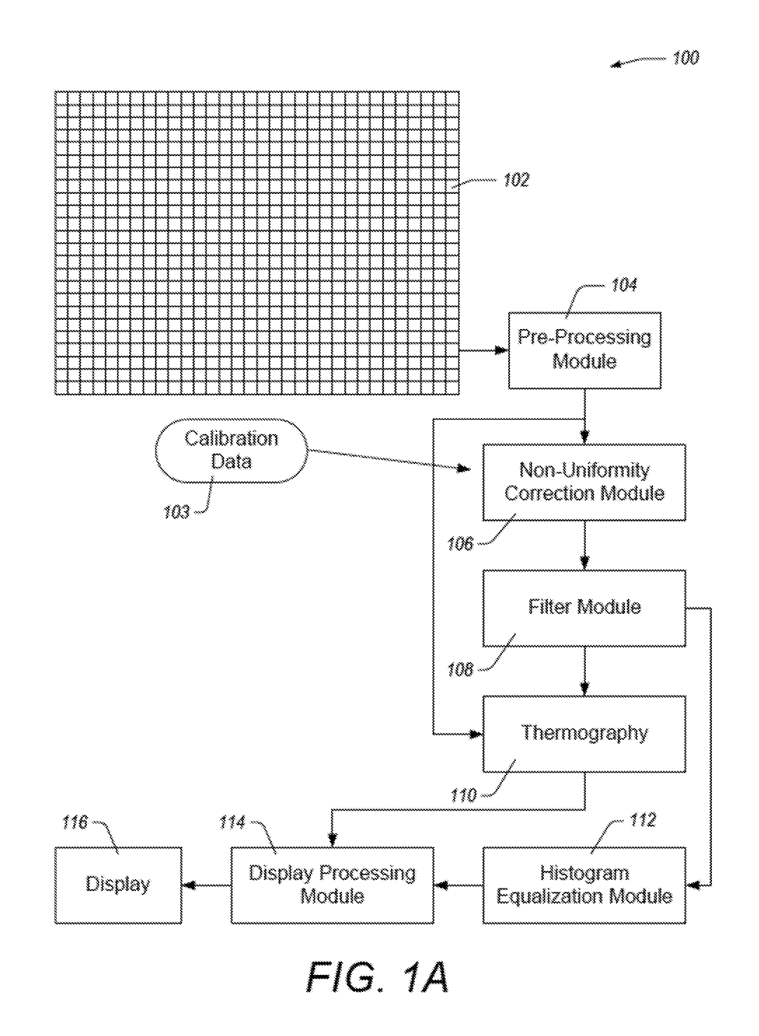

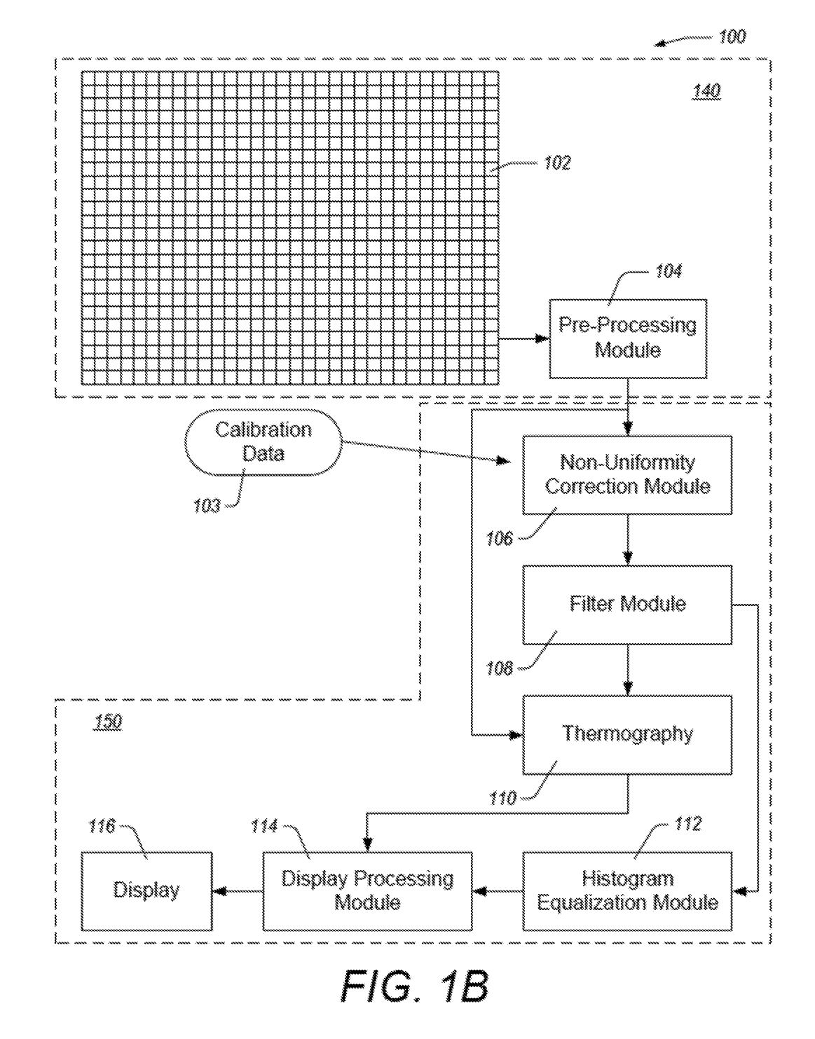

FIG. 1A illustrates a functional block diagram of an example imaging system 100 comprising an image sensor such as a focal plane array 102, a pre-processing module 104, a non-uniformity correction module 106, a filter module 108, a thermography module 110, a histogram equalization module 112, a display processing module 114, and a display 116. The focal plane array 102 can output a sequence of frames of intensity data (e.g., images, thermal images, etc.). Each frame can include an array of pixel values, each pixel value representing light intensity detected by a corresponding pixel on the focal plane array 102. The pixel values can be read out of the focal plane array 102 as a stream of serial digital data. In some embodiments, the pixel values are read out of the focal plane array 102 using read out electronics that process whole rows or whole columns of the focal plane array 102. In some embodiments, the read out electronics output the data as a stream of a few columns or rows at a time. For instance some FPAs utilize a technique known as an electronic rolling shutter which activates the photodetectors during image acquisition in discrete increments, or subframes, of the total frame and outputs the subframes as they are acquired accordingly. Thus, subsequent image processing may be configured to act on a frame or subframe basis, working through the entire frame or one or more subframes at a time. The format of the stream of data can be configured to conform to a desired, standard, or pre-defined format. The stream of digital data can be displayed as a two-dimensional image, such as by the display 116.

In some embodiments, the focal plane array 102 can be an array of microbolometers integrated with a read out integrated circuit (“ROIC”). The array of microbolometers can be configured to generate electrical signals in response to a quantity of thermal radiation or a temperature. The ROIC can include buffers, integrators, analog-to-digital converters, timing components, and the like to read the electrical signals from the array of microbolometers and to output a digital signal (e.g., 14-bit serial data separated into image frames). Additional examples of systems and methods associated with the focal plane array 102 are disclosed in U.S. patent application Ser. No. 14/292,124, entitled “Data Digitization and Display for an Imaging System,” filed May 30, 2014, the entire contents of which is incorporated by reference herein.

The focal plane array 102 can have calibration or other monitoring information associated with it (e.g., calibration data 103) that can be used during image processing to generate a superior image. For example, calibration data 103 may include bad pixel maps and/or gain tables stored in data storage and retrieved by modules in the imaging system 100 to correct and/or adjust the pixel values provided by the focal plane array 102. Calibration data 103 may include gain tables. As described herein, the focal plane array 102 can include a plurality of pixels with integrated read out electronics. The read out electronics can have a gain associated with it, wherein the gain may be proportional to the transimpedance of a capacitor in the electronics. This gain value, which may in some implementations take the form of a pixel gain table, may be used by the image processing modules of the imaging system 100. Additional examples of calibration data for the imaging system 100 are described in greater detail in U.S. patent application Ser. No. 14/829,490, entitled “Gain Calibration for an Imaging System,” filed Aug. 18, 2015, the entire contents of which is incorporated by reference herein. The calibration data 103 can be stored on the imaging system 100 or in data storage on another system for retrieval during image processing.

The imaging system 100 includes one or more modules configured to process image data from the focal plane array 102. One or more of the modules of the imaging system 100 can be eliminated without departing from the scope of the disclosed embodiments, and modules not shown may be present as well. The following modules are described to illustrate the breadth of functionality available to the disclosed imaging systems and not to indicate that any individual module or described functionality is required, critical, essential, or necessary. Modules such as those from 106 to 112 may be described as an “image processing chain.”

The imaging system 100 includes the pre-processing module 104. The pre-processing module 104 can be configured to receive the digital data stream from the focal plane array 102 and to perform pre-processing functions. Examples of such functions include frame averaging, high-level frame-wide filtering, etc. The pre-processing module 104 can output serial digital data for other modules.

As an example, the pre-processing module 104 can include conditional summation functionality configured to implement integration and averaging techniques to increase apparent signal to noise in image data. For example, the conditional summation functionality can be configured to combine successive frames of digitized image data to form a digitally integrated image. This digitally integrated image can also be averaged to reduce noise in the image data. The conditional summation functionality can be configured to sum values from successive frames for each pixel from the focal plane array 102. For example, the conditional summation functionality can sum the values of each pixel from four successive frames and then average that value. In some implementations, the conditional summation functionality can be configured to select a best or preferred frame from successive frames rather than summing the successive frames. Examples of these techniques and additional embodiments are disclosed in U.S. patent application Ser. No. 14/292,124, entitled “Data Digitization and Display for an Imaging System,” filed May 30, 2014, the entire contents of which is incorporated by reference herein.

As another example, the pre-processing module 104 can include adaptive resistor digital to analog converter (“RDAC”) functionality configured to determine and/or adjust for operating bias points of the focal plane array 102. For example, for an imaging system that includes a shutter, the imaging system 100 can be configured to adjust an operating bias point of the detectors in the focal plane array 102. The adaptive RDAC functionality can implement an adaptive operating bias correction method that is based at least in part on periodic measurement of a flat field image (e.g., an image acquired with the shutter closed). The adaptive RDAC functionality can implement an ongoing adjustment of the operating bias based at least in part on a measured or detected drift over time of the flat field image. The bias adjustment provided by the adaptive RDAC functionality may provide compensation for drift over time of the photodetectors and electronics due to effects such as temperature changes. In some embodiments, the adaptive RDAC functionality includes an RDAC network that can be adjusted to bring measured flat field data closer to a reference bias level. Additional examples of systems and methods related to the adaptive RDAC functionality are described in greater detail in U.S. patent application Ser. No. 14/829,500, now U.S. Pat. No. 9,584,750, filed Aug. 18, 2015, entitled “Adaptive Adjustment of the Operating Bias of an Imaging System,” the entire contents of which is incorporated by reference herein.

For a system such as the exemplary imaging system 100, pixel decimation may be provided by the pre-processing module 104 or equivalent. In such embodiments where pixel decimation is desired or advantageous, the remaining modules of the processing chain could all potentially benefit from a reduced image size.

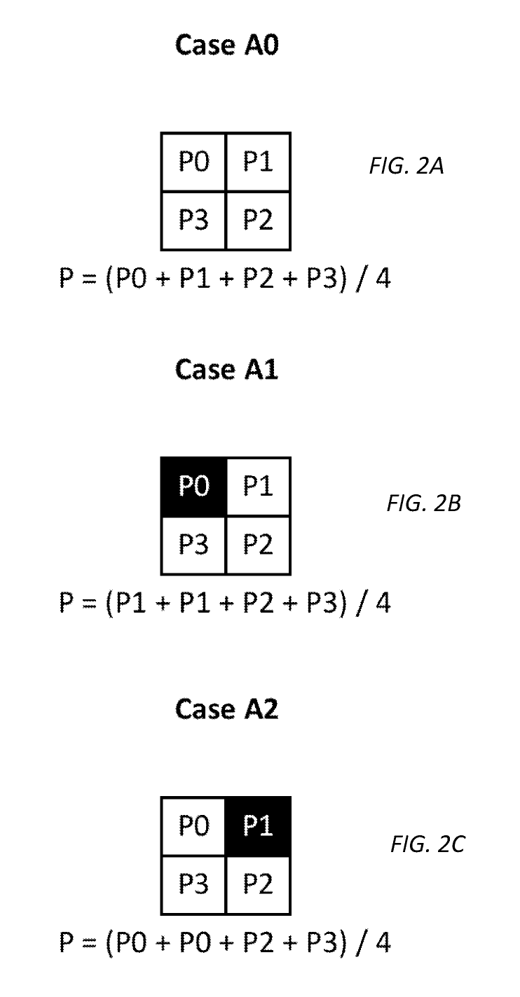

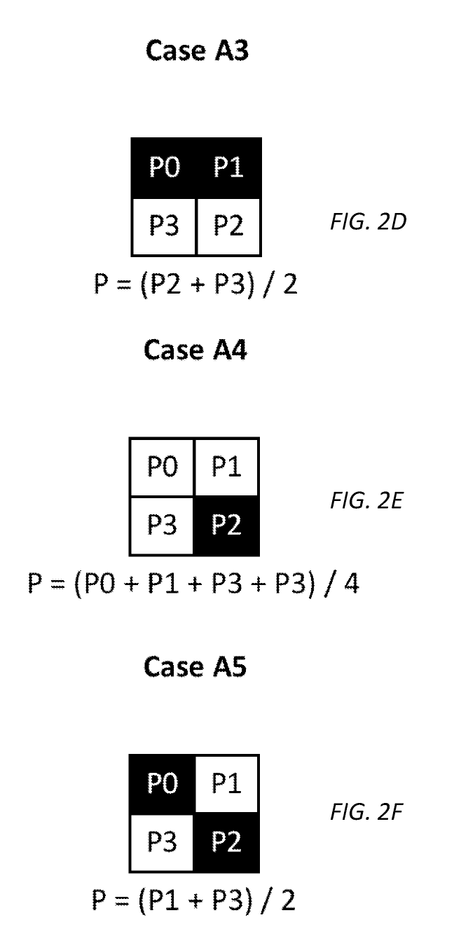

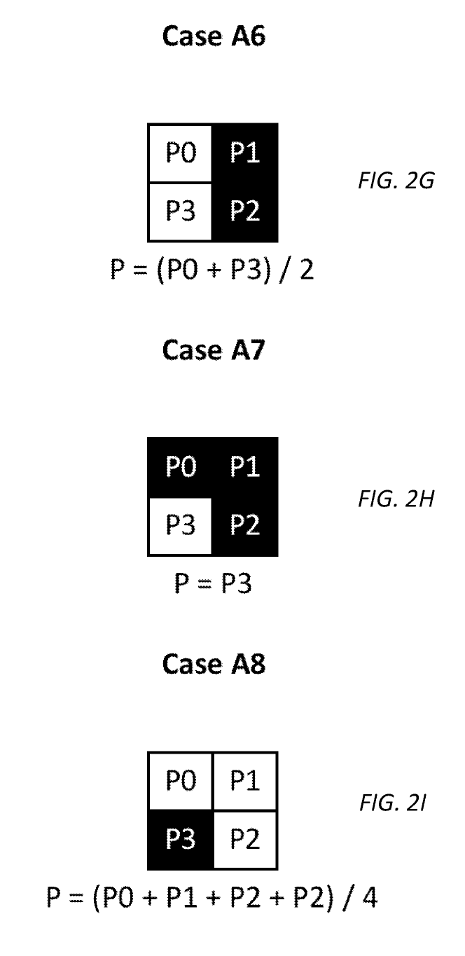

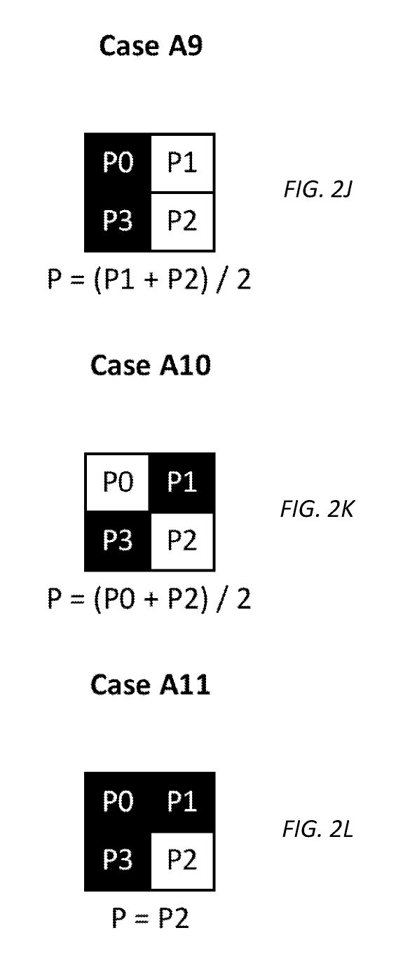

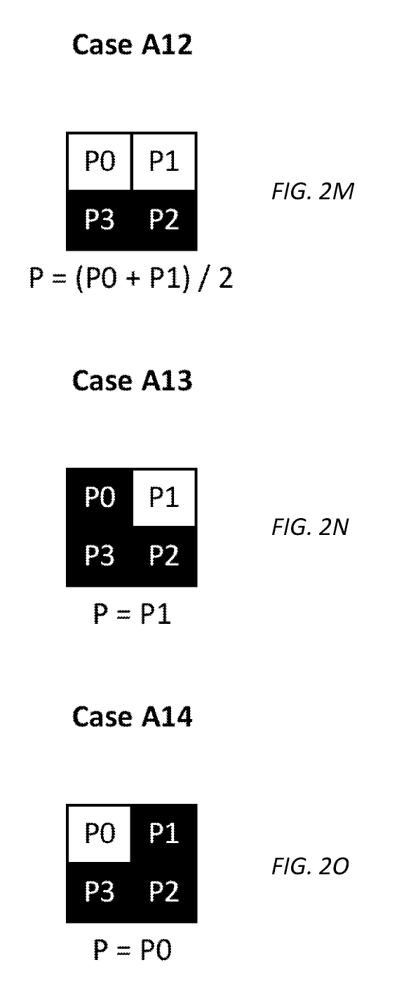

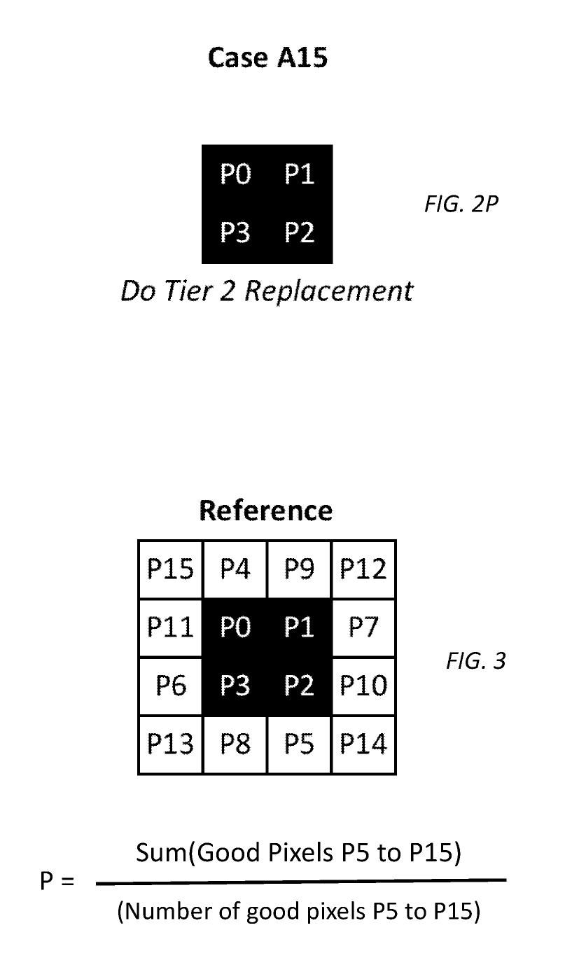

For image decimation with bad pixel replacement, as described herein, the pre-processing module 104 or equivalent can have access to a bad pixel map, which may be part of calibration data. In some embodiments, bad pixels may be identified during acquisition of image data through observation of pixel values and determination whether pixel values are outside of predetermined or targeted tolerances or whether the pixel values vary from their neighbors by more than predetermined or targeted thresholds. Examples of pixel decimation with bad pixel replacement are shown in FIGS. 2A-3.

After the pre-processing module 104, other processing modules can be configured to perform a series of pixel-by-pixel or pixel group processing steps. For example, the image processing system 100 includes a non-uniformity correction module 106 configured to adjust pixel data for gain and offset effects that are not part of the image scene itself, but are artifacts of the sensor. For example, the non-uniformity correction module 106 can be configured to receive a stream of digital data and correct pixel values for non-uniformities in the focal plane array 102. In some imaging systems, these corrections may be derived by intermittently closing a shutter over the focal plane array 102 to acquire uniform scene data. From this acquired uniform scene data, the non-uniformity correction module 106 can be configured to determine deviations from uniformity. The non-uniformity correction module 106 can be configured to adjust pixel data based on these determined deviations. In some imaging systems, the non-uniformity correction module 106 utilizes other techniques to determine deviations from uniformity in the focal plane array. Some of these techniques can be implemented without the use of a shutter. Additional examples of systems and methods for non-uniformity correction are described in U.S. patent application Ser. No. 14/817,847, entitled “Time Based Offset Correction for Imaging Systems,” filed Aug. 4, 2015, the entire contents of which is incorporated by reference herein.

After the pre-processing module 104, the imaging system 100 can include a high/low Cᵢₙₜ signal processing functionality configured to receive a stream of digital data (e.g., 14-bit serial data) from the pre-processing module 104. The high/low Cᵢₙₜ functionality can be configured to process the stream of digital data by applying gain tables, for example, as provided in the calibration data 103. The high/low Cᵢₙₜ functionality can be configured to process the stream of digital data using output of high/low integration components. Such high/low integration components can be integrated with the ROIC associated with the focal plane array 102. Examples of the high/low integration components are described in U.S. patent application Ser. No. 14/292,124, entitled “Data Digitization and Display for an Imaging System,” filed May 30, 2014, the entire contents of which is incorporated by reference herein.

The image processing system 100 includes a filter module 108 configured to apply one or more temporal and/or spatial filters to address other image quality issues. For example, the read out integrated circuit of the focal plane array can introduce artifacts into an image, such as variations between rows and/or columns. The filter module 108 can be configured to correct for these row- or column-based artifacts, as described in greater detail in U.S. patent application Ser. No. 14/702,548, now U.S. Pat. No. 9,549,130, entitled “Compact Row Column Noise Filter for an Imaging System,” filed May 1, 2015 the entire contents of which is incorporated by reference herein. The filter module 108 can be configured to perform corrections to reduce or eliminate effects of bad pixels in the image, enhance edges in the image data, suppress edges in the image data, adjust gradients, suppress peaks in the image data, and the like.

For example, the filter module 108 can include bad pixel functionality configured to provide a map of pixels on the focal plane array 102 that do not generate reliable data. These pixels may be ignored or discarded. In some embodiments, data from bad pixels is discarded and replaced with data derived from neighboring, adjacent, and/or near pixels. The derived data can be based on interpolation, smoothing, averaging, or the like. For the case where pixel decimation with bad pixel replacement is desired or advantageous, the bad pixel functionality may be placed earlier in the chain. For example, in some embodiments, pixel decimation can be performed after bad pixel replacement has been performed.

The filter module 108 can include peak limit functionality configured to adjust outlier pixel values. For example, the peak limit functionality can be configured to clamp outlier pixel values to a threshold value.

The filter module 108 can be configured to include an adaptive low-pass filter, a high-pass filter, a bandpass filter, or a combination of one or more of these filters. In some embodiments, the imaging system 100 applies either the adaptive low-pass filter or the high-pass filter, but not both. The adaptive low-pass filter can be configured to determine locations within the pixel data where it is likely that the pixels are not part of an edge-type image component. In these locations, the adaptive low-pass filter can be configured to replace specific pixel data, as opposed to wider image area data, with smoothed pixel data (e.g., replacing pixel values with the average or median of neighbor pixels). This can effectively reduce noise in such locations in the image. The high-pass filter can be configured to enhance edges by producing an edge enhancement factor that may be used to selectively boost or diminish pixel data for the purpose of edge enhancement. Additional examples of adaptive low-pass filters and high-pass filters are described in U.S. patent application Ser. No. 14/817,989, entitled “Local Contrast Adjustment for Digital Images,” filed Aug. 4, 2015, the entire contents of which is incorporated by reference herein.

The filter module 108 can be configured to apply optional filters to the image data. For example, optional filters can include, without limitation, averaging filters, median filters, smoothing filters, and the like. The optional filters can be turned on or off to provide targeted or desired effects on the image data.

The image processing system 100 includes a thermography module 110 configured to convert intensity to temperature. The light intensity can correspond to intensity of light from a scene and/or from objects in a field of view of the imaging system 100. The thermography module 110 can be configured to convert the measured light intensities to temperatures corresponding to the scene and/or objects in the field of view of the imaging system 100. The thermography module 110 can receive as input calibration data (e.g., calibration data 103). The thermography module 110 may also use as inputs raw image data (e.g., pixel data from the pre-processing module 104) and/or filtered data (e.g., pixel data from the filter module 108). Examples of thermography modules and methods are provided in U.S. patent application Ser. No. 14/838,000, entitled “Thermography for a Thermal Imaging Camera,” filed Aug. 27, 2015, the entire contents of which is incorporated by reference herein.

The image processing system 100 includes a histogram equalization module 112, or other display conversion module, configured to prepare the image data for display on the display 116. In some imaging systems, the digital resolution of the pixel values from the focal plane array 102 can exceed the digital resolution of the display 116. The histogram equalization module 112 can be configured to adjust pixel values to match the high resolution value of an image or a portion of an image to the lower resolution of the display 116. The histogram module 112 can be configured to adjust pixel values of the image in a manner that avoids using the limited display range of the display 116 on scene intensity values where there is little or no data. This may be advantageous for a user of the imaging system 100 when viewing images acquired with the imaging system 100 on the display 116 because it can reduce the amount of display range that is not utilized. For example, the display 116 may have a digital brightness scale, which corresponds to temperature for an infrared image where higher intensity indicates a higher temperature. However, the display brightness scale, for example a grey scale, is generally a much shorter digital word than the pixel sample words. For instance, the sample word of the pixel data may be 14 bits while a display range, such as grey scale, can be typically 8 bits. So for display purposes, the histogram equalization module 112 can be configured to compress the higher resolution image data to fit the display range of the display 116. Examples of algorithms and methods that may be implemented by the histogram equalization module 112 are disclosed in U.S. patent application Ser. No. 14/292,124, entitled “Data Digitization and Display for an Imaging System,” filed May 30, 2014, the entire contents of which is incorporated by reference herein.

The imaging system 100 includes a display processing module 114 configured to prepare the pixel data for display on the display 116 by, for example, selecting color tables to convert temperatures and/or pixel values to color on a color display. As an example, the display processing module can include a colorizer lookup table configured to convert pixel data and/or temperature data into color images for display on the display 116. The colorizer lookup table can be configured to display different temperatures of a thermally imaged scene using different color display lookup tables depending at least in part on the relationship of a temperature of a given scene to a threshold temperature. For example, when a thermal image of a scene is displayed, various temperatures of the scene may be displayed using different lookup tables depending on their relationship to the input temperature. In some embodiments, temperatures above, below, or equal to an input temperature value may be displayed using a color lookup table, while other temperatures may be displayed using a grey scale lookup table. Accordingly, the colorizer lookup table can be configured to apply different colorizing lookup tables depending on temperature ranges within a scene in combination with user preferences or selections. Additional examples of functionality provided by a display processing module are described in U.S. patent application Ser. No. 14/851,576, entitled “Selective Color Display of a Thermal Image,” filed Sep. 11, 2015, the entire contents of which is incorporated by reference herein.

The display 116 can be configured to display the processed image data. The display 116 can also be configured to accept input to interact with the image data and/or to control the imaging system 100. For example, the display 116 can be a touchscreen display.

The imaging system 100 can be provided as a standalone device, such as a thermal sensor. For example, the imaging system 100 can include an imaging system housing configured to enclose hardware components (e.g., the focal plane array 102, read out electronics, microprocessors, data storage, field programmable gate arrays and other electronic components, and the like) of the imaging system 100. The imaging system housing can be configured to support optics configured to direct light (e.g., infrared light, visible light, etc.) onto the image sensor 102. The housing can include one or more connectors to provide data connections from the imaging system 100 to one or more external systems. The housing can include one or more user interface components to allow the user to interact with and/or control the imaging system 100. The user interface components can include, for example and without limitation, touch screens, buttons, toggles, switches, keyboards, and the like.

In some embodiments, the imaging system 100 can be part of a network of a plurality of imaging systems. In such embodiments, the imaging systems can be networked together to one or more controllers.

FIG. 1B illustrates a functional block diagram of the example imaging system 100 illustrated in FIG. 1A, wherein functionality of the imaging system 100 is divided between a camera or sensor 140 and a processing device 150. Processing device 150 may be a mobile device or other computing device. By dividing image acquisition, pre-processing, signal processing, and display functions among different systems or devices, the camera 140 can be configured to be relatively low-power, relatively compact, and relatively computationally efficient compared to an imaging system that performs a majority or all of such functions on board. As illustrated in FIG. 1B, the camera 140 is configured to include the focal plane array 102 and the pre-processing module 104. In some embodiments, one or more of the modules illustrated as being part of the processing device 150 can be included in the camera 140 instead of in the processing device 150. In some embodiments, certain advantages are realized based at least in part on the division of functions between the camera 140 and the processing device 150. For example, some pre-processing functions can be implemented efficiently on the camera 140 using a combination of specialized hardware (e.g., field-programmable gate arrays, application-specific integrated circuits, etc.) and software that may otherwise be more computationally expensive or labor intensive to implement on the processing device 150. Accordingly, an aspect of at least some of the embodiments disclosed herein includes the realization that certain advantages may be achieved by selecting which functions are to be performed on the camera 140 (e.g., in the pre-processing module 104) and which functions are to be performed on the processing device 150 (e.g., in the thermography module 110).

An output of the camera 140 can be a stream of digital data representing pixel values provided by the pre-processing module 104. The data can be transmitted to the processing device 150 using electronic connectors (e.g., a micro-USB connector, proprietary connector, etc.), cables (e.g., USB cables, Ethernet cables, coaxial cables, etc.), and/or wirelessly (e.g., using BLUETOOTH, Near-Field Communication, Wi-Fi, etc.). The processing device 150 can be a smartphone, tablet, laptop, computer or other similar portable or non-portable electronic device. In some embodiments, power is delivered to the camera 140 from the processing device 150 through the electrical connectors and/or cables.

The imaging system 100 can be configured to leverage the computing power, data storage, and/or battery power of the processing device 150 to provide image processing capabilities, power, image storage, and the like for the camera 140. By off-loading these functions from the camera 140 to the processing device 150, the camera can have a cost-effective design. For example, the camera 140 can be configured to consume relatively little electronic power (e.g., reducing costs associated with providing power), relatively little computational power (e.g., reducing costs associated with providing powerful processors), and/or relatively little data storage (e.g., reducing costs associated with providing digital storage on the camera 140). This can reduce costs associated with manufacturing the camera 140 due at least in part to the camera 140 being configured to provide relatively little computational power, data storage, and/or power, because the imaging system 100 leverages the superior capabilities of the mobile electronic device 150 to perform image processing, data storage, and the like. For a distributed system where image decimation is desirable, performing the decimation in the pre-processing module on the camera, or very early in the chain performed on the processing device may be advantageous.

### Example Pixel Decimation Systems and Methods

As described above the imaging sensor usually is an array of photodetectors, and may be square or rectangular, so that an image from the sensor is an array of pixel values corresponding to each photodetector or pixel. The image resolution of the system is determined by the optics, the pixel size, and the number of pixels. The image sensor is often manufactured in a microelectronics foundry. Since microelectronics manufacturing utilizes a unique set of tooling for each design, manufacturers of low-cost imaging systems and in particular thermal imaging systems with their increased complexity, may find it advantageous to limit the number of designs they manufacture to spread the significant start-up costs of bringing a design into large-scale production over as many imaging system products as possible. Thus, it may be advantageous to utilize arrays of higher pixel count than required for a given system. To recover some of the cost of using a higher resolution array for a less demanding application, it may be advantageous to utilize arrays of a quality that would not be acceptable for a high resolution application, but if fewer actual image pixels are required may be useful for a lower performance system.

Additionally, the requirement for resolution of an imaging system may be situational. For instance in a tracking system it may be advantageous to have a broad survey mode that looks at scenes with high resolution at a low refresh rate and a tracking mode that can tolerate lower resolution but requires a higher refresh rate. Or a low power mode that views at lower resolution switchable to high power, high resolution mode may be desirable. Thus, it may be advantageous to trade-off resolution, speed, and/or power consumption dynamically in an imaging system.

Image decimation, the process of taking a large size image, or a high resolution image, and mapping it into a corresponding lower size image, or lower resolution image, may be advantageous for both of these situations. Although it is possible to design image decimation capabilities into the readout electronics of a sensor, such designs increase the complexity and cost of the sensor and may not be very flexible. Accordingly, described herein are image decimation methods and systems that perform the decimation in the signal processing chain, the programmable part of the system, usually early in the chain to increase or maximize the advantages gained.

The image processing portion of the system acquires frames (or in some cases subframes) of image data with the pixels in the frames mapped one to one to the photodetectors in the imaging array. Thus the acquired image frames are of a size (number of pixels) corresponding to the number of photodetectors in the array. To decimate the image, dividing the frame into a number of kernels may be performed. These kernels may be of any size and number, but for most applications, the kernels may preferably be of a uniform size that divides evenly into the frame size. For instance a 200×160 array has 32 k pixels. If 2×2 kernels are utilized, there will be 100×80 kernels or 8 k kernels. If 4×4 kernels are utilized, there will be 50×40 kernels or 2 k kernels. If 5×4 kernels are utilized, there will be 40×40 kernels or 1600 kernels. The same concept applies to larger or smaller arrays and larger kernels. To decimate the image, the pixels from each kernel are replaced by a smaller number of pixels, whose value is derived from the original kernel pixel values, or possibly also from or including neighboring pixel values (e.g., pixels adjacent to or near the original kernel).

Again it is possible to replace the kernel pixels with more than one decimated pixel, but usually it is convenient to replace the kernel pixels with one derived pixel. Thus for the 32 k sensor example with 2×2 kernels, the decimated image would have 8 k pixels. A variety of approaches may be used to derive the decimated pixel value. For instance the decimated pixel may be assigned the value of the average of the kernel pixels. Or it may be assigned the median of the kernel pixel values. Other derivations may be used such as min/max, peak, middle, low, or any of the above with high low limits as well.

Calculations such as average or median are very computationally efficient. So if the decimation process is performed early in the signal processing chain, the majority of the signal processing chain operations would operate on a smaller array size and therefore could be performed much faster, or slower with less powerful devices, or slower with the same devices at reduced power consumption. Accordingly, one sensor design could be used for a high resolution application with powerful computing resources, such as a sensor mated to a powerful processing device. The same array could be used with smaller image size in a less powerful system with limited processing, e.g., a compact unit such as a handheld thermal camera utilizing an onboard FPGA as the processing device. Or system parameters can be varied dynamically. For example the array is sampled at output frame rate at 32 Hz, but processing device can only execute the image processing train at 8 Hz for the full image. Then the full image will only be display refreshed at 8 Hz. If the image is decimated by 4, the image processing train would be able to process images much faster and the refresh rate could be much higher for the decimated image. In another example, the image processing chain uses 25 mW at processing the entire sensor image, but only 10 mW processing a decimated image. Thus, parameters such as processor design, system throughput, and power consumption can be varied easily by programming alone by engaging or not engaging decimation, either in the system configuration or even dynamically during use, all using the same sensor array design.

Another issue which may be advantageously affected by image decimation is sensor quality. For example, for low cost thermal imaging systems, it may be difficult to achieve cost-effective manufacturing yields without some number of bad pixels in the sensor arrays. Accordingly, as described above, many imaging systems utilizing such sensors have bad pixel replacement modules in their signal processing chain. However, at some point too many bad pixels may not be tolerable for a desired resolution, quality, or image size. However, the number of bad pixels that are acceptable in a 32 k array decimated to 8 k, for example, is much higher than it is if all 32 k pixels are displayed. Thus, an array design for a certain image size for certain applications may be rejected, but that same array may be perfectly acceptable for a smaller image size application. Thus, a portion of parts that would be rejected at initial test for 32 k applications may be utilized for, for example, 8 k applications with decimation. This is a great advantage for a low-cost imager manufacturer, because it both increases yield at sensor manufacturing and allows for common platform design (e.g., the interface to the sensor) for a wide range of performance applications.

By way of illustration, a particular implementation will be described for decimation with bad pixel replacement for 2×2 kernels. Referring to FIGS. 2A through 2P, P is the decimated resulting pixel, and P0, P1, P2, and P3 are the kernel pixels. Good pixels are shown in white and bad pixels are shown in black. Each case with at least one good pixel is shown in FIGS. 2A-2O. The decimated pixel derivation in the figures is essentially the average of the good pixels only in a kernel. Using median, or some other calculation may also yield good results. The image quality from a 32 k sensor with a large number of bad pixels decimated to 8 k has been shown to very good, thus allowing arrays that would otherwise be rejected to be utilized successfully. Other variations on computing the decimated pixel value are within the scope of this disclosure. For example, where there is a bad pixel, one or more pixel values within the kernel can be used to replace the bad pixel value and then the average of the pixel values of the kernel can be calculated to determine the decimated pixel value. Examples of this are shown in FIGS. 2B, 2C, 2E, and 2I. As another example, the remaining good pixels can be averaged to determine the decimated pixel value. Using the example illustration in FIG. 2B, this would be equivalent to setting the decimated pixel value, P, to (P1+P2+P3)/3. Again, using the average value of good pixels in a kernel for determining the decimated pixel value is merely exemplary and other functions, calculations, or mathematical processes may be used to determine the decimated pixel value using the kernel pixel values.

FIG. 3 shows a specific implementation, designated as “tier two replacement” for the case where all pixels in a kernel are bad, as shown in FIG. 2P. In this example P is the average of the neighboring good pixels. Median or other approach may be acceptable. More than just the closest neighbors may be used. Fewer than all of the closest neighbors may also be used. However, the image quality for bad kernel replacement is not as desirable as for even one good pixel in a kernel, so too many bad kernels may not be tolerable even for decimated images.

### Example Method of Decimating an Image

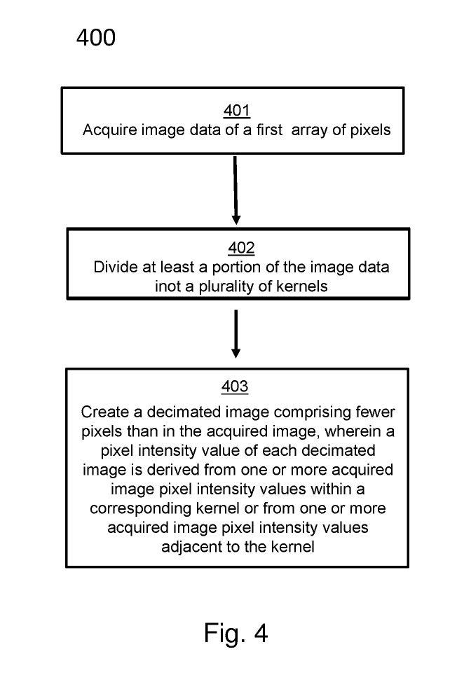

FIG. 4 illustrates a flow chart of an example method 400 for decimating an image. The method 400 can be implemented using one or more hardware components in a thermal imaging system or image processing system. For ease of description, the method 400 will be described as being performed by the imaging system 100 described herein with reference to FIGS. 1A and 1B. However, one or more of the steps of the method 400 can be performed by any module, such as the filter module 108 or pre-processing module 104, or combination of modules in the imaging system 100. Similarly, any individual step can be performed by a combination of modules in the imaging system 100.

In block 401, the imaging system receives image data comprising an array of pixel values. In some embodiments, the pixel values, Pᵢⱼ, represent a two-dimensional array of pixel values where the indices i and j are used to indicate a particular pixel value in the array. The image data can be acquired with an image sensor that is part of the imaging system. The image data can be received from a data storage or memory or directly through a signal processing path from the image sensor that acquired the image data. In certain implementations, the image data is acquired with a focal plane array of an infrared camera or thermal sensor.

In block 402, the imaging system divides the image data into a plurality of kernels. The kernels can each be of the same size, but may also be of differing sizes. The kernels can be square or can be rectangular or have some other desirable configuration. When calculating decimated images, the kernels can be made to be non-overlapping. In some embodiments, however, kernels may be allowed to overlap. In block 403, the imaging system creates a decimated image of a reduced number of pixels compared to the acquired image wherein each pixel in the decimated image is derived from at least one of the pixels (or good pixels) of a corresponding kernel or neighboring pixels (or good neighboring pixels) of a corresponding kernel. As described herein, a decimated pixel for a kernel can correspond to an average (or other mathematical process) of the good pixels in the kernel. In some embodiments, one or more decimated pixels can be determined for a given kernel. In some embodiments, such as where there are insufficient good pixels in a kernel, pixels that neighbor the kernel can be used to calculate the value of the decimated pixel(s) for the kernel.

In some embodiments, the decimation is at or near the front of the signal processing chain, allowing for all or most subsequent signal processing to operate on smaller image size. In some embodiments, the decimation process has access to a bad pixel map and performs the decimation with integrated bad pixel replacement.

The embodiments described herein are exemplary. Modifications, rearrangements, substitute processes, etc. may be made to these embodiments and still be encompassed within the teachings set forth herein. One or more of the steps, processes, or methods described herein may be carried out by one or more processing and/or digital devices, suitably programmed.

Depending on the embodiment, certain acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a processor configured with specific instructions, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. For example, the bad pixel map described herein may be implemented using a discrete memory chip, a portion of memory in a microprocessor, flash, EPROM, or other types of memory.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. A software module can comprise computer-executable instructions which cause a hardware processor to execute the computer-executable instructions.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A method for pixel decimation for an imaging system comprising an imaging sensor with an array of photodetectors, the method comprising:
acquiring image data from the array of photodetectors, the acquired image data comprising an array of pixel intensity values each associated with a pixel of an acquired image;
dividing at least a portion of the acquired image data into a plurality of kernels, each kernel comprising the pixel intensity values associated with two or more of the pixels of the acquired image; and
creating a decimated image comprising a number of pixels relatively smaller than the number of pixels in the acquired image, wherein a pixel intensity value of each pixel of the decimated image is derived from at least one of:
one or more of the pixel intensity values within a kernel corresponding to the pixel of the decimated image, and
one or more pixel intensity values of the acquired image data associated with pixels adjacent to the corresponding kernel.

2. The method of claim 1 wherein subsequent image processing and display is performed on the decimated image.

3. The method of claim 1, wherein each pixel of the decimated image replaces two or more pixels of the corresponding kernel.

4. The method of claim 3, wherein each pixel of the decimated image replaces all of the pixels of the corresponding kernel.

5. The method of claim 1, wherein the pixel intensity value of each decimated image pixel is derived from good pixels of the corresponding kernel.

6. The method of claim 5, wherein decimated image pixels include one or more of an average, a median, a peak value, a middle value, or a low value of the good pixels of the corresponding kernel.

7. The method of claim 1, wherein if a kernel has no good pixels, the pixel intensity values of decimated image pixels corresponding to the kernel are derived from the pixel intensity values of good pixels adjacent to the kernel.

8. The method of claim 4, wherein the kernels are 2×2 pixels and the number of pixels in the decimated image is ¼ the number of pixels of the acquired image.

9. The method of claim 4, wherein decimation is performed on the acquired image and subsequent image processing is performed on the replacement pixels.

10. The method of claim 1, wherein the imaging sensor comprises an infrared focal plane array.

11. A thermal imaging system comprising:
an imaging array comprising an infrared focal plane array, the infrared focal plane array configured to generate signals corresponding to levels of infrared light incident on the infrared focal plane array;
a detector circuit comprising readout electronics that receive the generated signals and output image data comprising an array of pixel intensity values; and
a system controller configured to:
acquire image data from the array of photodetectors, the acquired image data comprising an array of pixel intensity values each associated with a pixel of an acquired image;
divide at least a portion of the image data into a plurality of kernels, each kernel comprising the pixel intensity values associated with two or more of the pixels of the acquired image; and
create a decimated image comprising a number of pixels relatively smaller than the number of pixels in the acquired image, wherein a pixel intensity value of each pixel of the decimated image is derived from at least one of:
one or more of the pixel intensity values within a kernel corresponding to the pixel of the decimated image, and
one or more pixel intensity values of the acquired image data associated with pixels adjacent to the corresponding kernel.

12. The thermal imaging system of claim 11, wherein the system controller is further configured to perform subsequent image processing and display on the decimated image.

13. The thermal imaging system of claim 11, wherein each pixel of the decimated image replaces two or more pixels of the corresponding kernel.

14. The thermal imaging system of claim 13, wherein each pixel of the decimated image replaces all of the pixels of the corresponding kernel.

15. The thermal imaging system of claim 11, wherein the pixel intensity value of each decimated image pixel is derived from good pixels of the corresponding kernel.

16. The thermal imaging system of claim 15, wherein decimated image pixels include one or more of an average, a median, a peak value, a middle value, or a low value of the good pixels of the corresponding kernel.

17. The thermal imaging system of claim 11, wherein if a kernel has no good pixels, the pixel intensity values of the decimated image pixels corresponding to the kernel are derived from one or more of an average, a median, a peak value, a middle value, or a low value of the pixel intensity values of good pixels adjacent to the kernel.

18. The thermal imaging system of claim 14, wherein the kernels are 2×2 pixels and the number of pixels in the decimated image is ¼ the number of pixels of the acquired image.

19. The thermal imaging system of claim 14, wherein decimation is performed on the acquired image and subsequent image processing is performed on the replacement pixels.

20. The thermal imaging system of claim 11, wherein the imaging sensor comprises an infrared focal plane array.
